(19) United States
(12) Patent Application Publication
(10) Pub. No.: US 2026/0211581 A1
(43) Pub. Date: Jul. 23, 2026

(54) MEMORY SYSTEMS, HOSTS, ELECTRONIC DEVICES, METHODS OF STORING DATA AND MEMORY MEDIUMS

(71) Applicant: YANGTZE MEMORY TECHNOLOGIES CO., LTD., Wuhan (CN)

(72) Inventors: Wei XIANG, Wuhan (CN); Kang LI, Wuhan (CN); Caiyun DONG, Wuhan (CN); Yanyan REN, Wuhan (CN)

(21) Appl. No.: 19/182,202

(22) Filed: Apr. 17, 2025

(30) Foreign Application Priority Data
Nov. 18, 2024 (CN) 2024116518851

(51) Int. Cl. G06F 3/06

(52) U.S. Cl. CPC G06F 3/0659; G06F 3/0604; G06F 3/0647; G06F 3/0679

(57) ABSTRACT

A memory system includes a memory device and a memory controller. The memory controller is configured to: receive a first write request, wherein the first write request comprises a first type data; in response to the first write request, label a first data tag for the first type of data, wherein the first data tag indicates that the first type of data is stored in a first type of memory cell of the memory device.

### CROSS-REFERENCE TO RELATED APPLICATIONS

The present disclosure claims priority to Chinese Patent Application No. 2024116518851, which was filed Nov. 28, 2024, and is hereby incorporated herein by reference in its entirety.

### TECHNICAL FIELD

The present disclosure relates to memory technologies, and in particular, to a memory system, a host, an electronic device, a method for storing data, and a memory medium.

### BACKGROUND

The three-dimensional (3D) memory comprises a plurality of memory cells, and a type of the memory cell may be classified into a Single-Level Cell (SLC), a Multi-Level Cell (MLC), a Trinary-Level Cell (TLC), and a Quad-Level Cell (QLC), etc., depending on the amount of data the memory cell can store.

### SUMMARY

The present disclosure provides a memory system, a host, an electronic device, a method for storing data and a memory medium. The technical solution is as follows:

According to one aspect, a memory system is provided. The memory system comprises a memory device and a memory controller. the memory controller is configured to receive a first write request, and label a first data tag for the first type of data in response to the first write request. The first write request comprises a first type of data. The first data tag indicates that the first type of data is stored in a first type of memory cell of the memory device.

In some examples, the first write request comprises a first identification bit, the first identification bit is marked as a first value, the first value represents a first request format corresponding to the first write request, and the first request format is a format set for the first type of data.

In some examples, the memory controller is further configured to label the first data tag for the first type of data based on the first value of the first identification bit.

In some examples, the memory controller is further configured to: receive a second write request, and write the second type of data into the first type of memory cell or a second type of memory cell in the memory device in response to the second write request. The second write request comprises a second type of data. The first type of memory cell is configured to be capable of being written with N-bit data. The second type of memory cell is configured to be capable of being written with M-bit data, and N is less than M.

In some examples, the first type of data comprises system file data of an operating system, and the second type of data comprises data other than the system file data.

In some examples, a second value of the first identification bit in the second write request is different from the first value.

In some examples, the memory controller is further configured to: send a write instruction to the memory device, wherein the write instruction comprises the first type of data labeled with the first data tag and a first memory address corresponding to the first type of data;

The memory device is further configured to: receive the write instruction; in response to the write instruction, write the first type of data labeled with the first data tag in the first type of memory cell based on the first memory address.

In some examples, the memory controller is further configured to: control the first type of data to perform data migrate between the first type of memory cell based on the first data tag.

In some examples, the memory controller is further configured to receive a read request for requesting to read the first type of data, and in response to the read request, send a read instruction to the memory device. The read instruction comprises an address of a first type of memory cell for storing the first type of data. The memory device is configured to receive the read instruction, and in response to the read instruction, read the first type of data from the first type of memory cell.

In some examples, the memory device comprises the first type of memory cell and the second type of memory cell. The first type of memory cell comprises at least one of a Single-Level Cell (SLC), a Multi-Level Cell (MLC), and a Trinary-Level Cell (TLC). The second type of memory cell comprises a Quad-Level Cell (QLC).

According to another aspect, a host is provided. The host comprises an interface and a processor coupled to the interface and configured to: send a first write request to a memory controller through the interface. The first write request comprises a first type of data. The first write request indicates the memory controller to label a first data tag for the first type of data. The first data tag indicates that the first type of data is stored in a first type of memory cell of a memory device.

In some examples, the processor is further configured to send a second write request to the memory controller through the interface. The second write request comprises a second type of data, and the second write request indicates to write the second type of data to the first type of memory cell or a second type of memory cell of the memory device. The first type of memory cell is configured to be capable of being written with N-bit data, and the second type of memory cell is configured to be capable of being written with M-bit data, and N is less than M.

In some examples, the first write request comprises a first identification bit. The first identification bit is marked as a first value, the first value represents a first request format corresponding to the first write request, and the first request format is a format set for the first type of data. A second value of the first identification bit in the second write request is different from the first value.

In some examples, the first type of data comprises system file data of an operating system, and the second type of data comprises data other than the system file data.

In some examples, the processor runs an operating system, and the first type of data comprises system file data of the operating system. The processor is further configured to automatically generate the first write request during an installation of the operating system. Or, the processor is further configured to, after the operating system is installed, receive a write operation for the operating system, and generate the first write request in response to the write operation.

In some examples, the processor is further configured to: send a read request for requesting to read the first type of data to the memory controller through the interface when the operating system is initiated, wherein the read request indicates to read the first type of data from the first type of memory cell.

In some examples, the memory device comprises the first type of memory cell and the second type of memory cell. The first type of memory cell comprises at least one of a Single-Level Cell (SLC), a Multi-Level Cell (MLC), and a Trinary-Level Cell (TLC). The second type of memory cell comprises a Quad-Level Cell (QLC).

In another aspect, a method for storing data is provided. The method comprises: receiving a first write request, and labeling a first data tag for the first type of data in response to the first write request. The first write request comprises a first type of data. The first data tag indicates that the first type of data is stored in a first type of memory cell.

In some examples, the first write request comprises a first identification bit, the first identification bit is marked as a first value, the first value represents a first request format corresponding to the first write request, and the first request format is a format set for the first type of data.

In some examples, the labeling the first data tag for the first type of data in response to the first write request comprises labeling the first data tag for the first type of data based on the first value of the first identification bit.

In some examples, the method further comprises: receiving a second write request, and writing the second type of data into the first type of memory cell or a second type of memory cell in the memory device in response to the second write request. The second write request comprises a second type of data. The first type of memory cell is configured to be capable of being written with N-bit data, and the second type of memory cell is configured to be capable of being written with M-bit data, and N is less than M.

In some examples, the first type of data comprises system file data of an operating system, and the second type of data comprises data other than the system file data.

In some examples, a second value of the first identification bit in the second write request is different from the first value.

In some examples, the method further comprises: writing the first type of data labeled with the first data tag into the first type of memory cell.

In some examples, the writing the first type of data labeled with the first data tag into the first type of memory cell comprises: generating a write instruction in response to the first write request, and writing the first type of data labeled with the first data tag in the first type of memory cell based on the first memory address in response to the write instruction. The write instruction comprises the first type of data labeled with the first data tag and a first memory address corresponding to the first type of data.

In some examples, the method further comprises: controlling the first type of data to perform data migrate between the first type of memory cell based on the first data tag.

In some examples, the method further comprises: receiving a read request for requesting to read the first type of data, and generating a read instruction in response to the read request. The read instruction comprises an address of a first type of memory cell for storing the first type of data in the memory device. The method further comprises reading the first type of data from the first type of memory cell in response to the read instruction.

In some examples, the memory device comprises the first type of memory cell and the second type of memory cell. The first type of memory cell comprises at least one of a Single-Level Cell (SLC), a Multi-Level Cell (MLC), and a Trinary-Level Cell (TLC); The second type of memory cell comprises a Quad-Level Cell (QLC).

According to another aspect, an electronic device is provided. The electronic device comprises one or more memory systems according to any one of the above examples, and a host coupled to the memory system according to any one of the above examples.

According to another aspect, a computer-readable memory medium storing an instruction therein is provided, the instruction, when executed on a control circuit, implements a method for storing data according to the above examples of the present disclosure.

### BRIEF DESCRIPTION OF THE DRAWINGS

In order to more clearly illustrate the technical solutions in the examples of the present disclosure, the accompanying drawings that need to be used in the description of the examples are briefly described below, and it is apparent that the drawings in the following description are merely some examples of the present disclosure, and for those of ordinary skill in the art, other drawings may be obtained based on these drawings without creative work.

FIG. 1 is a schematic diagram of a system having a memory system according to an example of the present disclosure.

FIG. 2 is a schematic structural diagram of a 3D memory device according to an example of the present disclosure.

FIG. 3 is a flowchart of a method for storing data according to an example of the present disclosure.

FIG. 4 is a schematic diagram of a labeling of specific data according to an example of the present disclosure.

FIG. 5 is a schematic diagram of a first request format according to an example of the present disclosure.

FIG. 6 is a flowchart of a method for writing other types of data according to an example of the present disclosure.

FIG. 7 is a schematic diagram of a format of a specific write request and a normal write request according to an example of the present disclosure.

FIG. 8 is a flowchart of a method for writing a first type of data according to an example of the present disclosure.

FIG. 9 is a flowchart of a method for migrating data based on a specific data tag according to an example of the present disclosure.

FIG. 10 is a schematic diagram of data migration of a first type of data according to an example of the present disclosure.

FIG. 11 is a schematic diagram of data migration of other types of data according to an example of the present disclosure.

FIG. 12 is a flowchart of a method for reading data according to an example of the present disclosure.

FIG. 13 is a schematic logical flowchart of an operation for storing data according to an example of the present disclosure.

FIG. 14 is a schematic structural diagram of a host according to an example of the present disclosure.

FIG. 15 is a schematic structural diagram of a memory system according to an example of the present disclosure

FIG. 16 is a schematic structural diagram of a memory device according to an example of the present disclosure.

### DETAILED DESCRIPTION

The examples of the present disclosure are described in detail below with reference to the accompanying drawings.

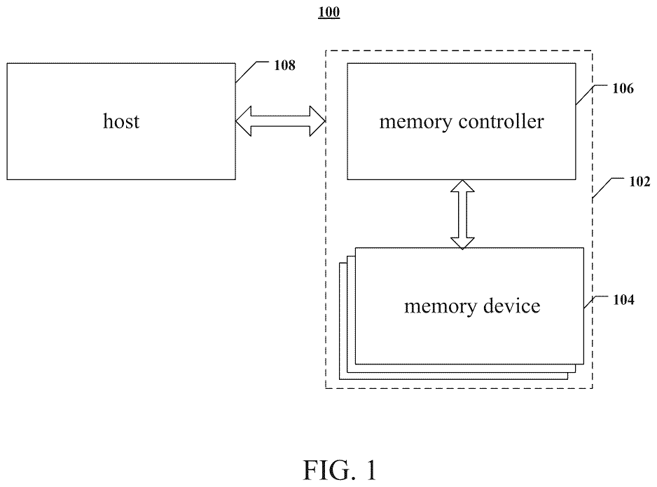

The method for storing data according to the examples of the present disclosure may be applied to a system having a memory system, as shown in FIG. 1, the system 100 includes a memory system 102, and a host 108 coupled to the memory system 102. The memory system 102 includes one or more memory devices 104, and a memory controller 106 coupled to the one or more memory devices 104 and configured to control the memory device 104.

The memory device may be a 3D memory device, for example, may be a 3D NAND flash.

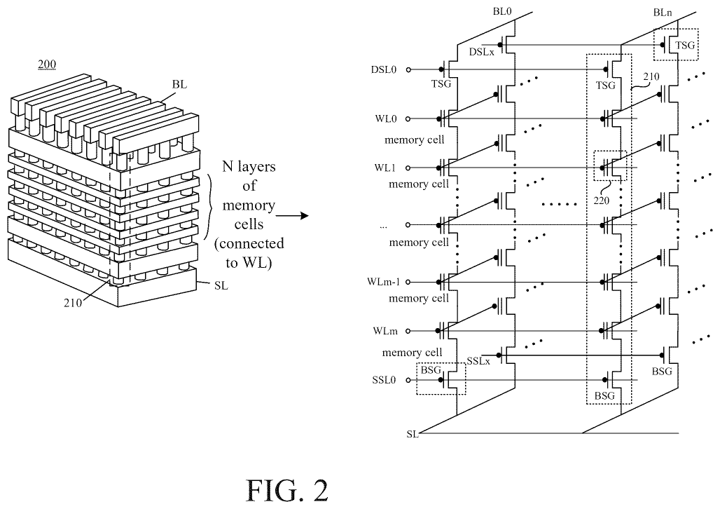

3D memory is a multi-layer stacked memory device, for example, the 3D memory device is a 3D NAND flash. As shown in FIG. 2, the plurality of memory strings 210 included in the 3D memory device 200 are arranged in a direction parallel to the bearing surface of the substrate, and the plurality of memory cells 220 in each memory string 210 are arranged in a direction perpendicular to the bearing surface of the substrate. For example, the plurality of memory cells included in the 3D memory device are arranged in a three-dimensional array on a substrate and form a memory array.

One end of the memory string 210 is connected to a bit line (BL), and the other end of the memory string 210 is connected to a source line (SL).

The memory cells in each memory string are also connected to memory cells in other memory strings through word line (WL). For example, if each memory string may include m+1 memory cells, the 3D memory device may include m+1 word lines WL <m:0 >, where each word line is connected to a part of memory cells located in the same layer (e.g., having the same height with respect to the substrate). M is a positive integer, and a value of m is not limited in this example of the present disclosure.

The memory string 210 further includes an upper select transistor connected to the drain of the memory cell, and a lower select transistor connected to the source of the memory cell. The upper select transistor is also referred to as a top select gate (TSG) or a drain select transistor. The lower select transistor is also referred to as a Bottom Select Gate (BSG) or a source select transistor.

A gate of the TSG is connected to a drain select line (DSL), a source of the TSG is connected to a drain of the memory cell, and a drain of the TSG is connected to the bit line.

A gate of the BSG is connected to a source select line (SSL), a drain of the BSG is connected to a source of the memory cell, and a source of the BSG is connected to a source line.

It can be seen from FIG. 2 that the memory cells in the memory string 210 share a set of WLs with memory cells in other memory strings. Assuming that each memory string includes m+1 memory cells, the 3D memory device may include m+1 WLs: WL0 to WLm, where m is an integer greater than 1. Each WL is connected to each memory cell located in the same layer (e.g., having the same height with respect to the bearing surface of the substrate). Alternatively, it can be understood that: the control gates of each memory cell located in the same layer and the gate connection lines between the control gates form one WL.

Depending on the amount of data that can be stored by the memory cell, the type of the memory cell can be classified into SLC, MLC, TLC and QLC, etc. Each SLC can store 1 bit of data, each MLC can store 2 bits of data, each TLC can store 3 bits of data, and each QLC can store 4 bits of data. In the 3D memory device, data stored in each memory cell located in the same layer may constitute k memory pages. K is a number of bits of data that can be stored in each memory cell.

In the examples of the present disclosure, the memory cells in the 3D memory device may be a field effect transistor capable of storing data, such as a floating gate field effect transistor or a charge trapping field effect transistor. The TSG and the BSG may be common field effect transistors, or may be field effect transistors capable of storing data. The floating gate field effect transistor includes a source, a drain, and two gates. Both gates are conductors, one of the two gates is a control gate (CG), and the other gate is a floating gate (FG), simply referred to a FG. The control gate is used for connecting a word line, and the floating gate is used for storing data. The charge trapping field effect transistor includes a source, a drain, a control gate and a charge trapping layer, where the charge trapping layer is a unit for storing data, and the charge trapping layer is made of an insulating material such as silicon nitride. Hereinafter, the principle of writing data to the memory cell will be described by taking the charge trapping effect transistor as an example.

When writing data into the memory cell, a programming voltage can be applied to the control gate of the charge trapping field effect transistor so that electrons in the channel of the charge trapping field effect transistor tunnel to the charge trapping layer. By controlling the programming voltage, the number of electrons tunneling to the charge trapping layer can be controlled, thereby controlling the threshold voltage Vth of the charge trapping field effect transistor. Generally, the higher the amount of charge stored in the charge trapping layer, the higher the threshold voltage Vth of the charge trapping field effect transistor. It can be understood that when the threshold voltage Vth of the charge trapping field effect transistor is different, the voltage required to be applied on the control gate of the charge trapping field effect transistor when controlling the charge trapping field effect transistor to turn on is different. Therefore, the threshold voltage Vth of the charge trapping field effect transistor can reflect the contents of the data stored therein.

In the writing process, charge trapping field effect transistors use charge traps in the insulating layer to store electrons, and the tunneling and capture processes of these electrons determine the threshold voltage of the memory cell. By accurately controlling the programming voltage, the number of electrons stored in the charge trap can be accurately controlled, thereby achieving writing data to the memory cell. This mechanism enables the charge trapping field effect transistor to have high flexibility and reliability in data storage, while also improving the durability and data retention capability of the memory cell. By measuring and comparing the threshold voltages of different memory cells, the data stored in each cell can be accurately read.

In the 3D memory device, the channels of each memory cell in each memory string can be sequentially connected and form a columnar structure perpendicular to the substrate.

While programming memory device, for example, an MLC can be configured to store two data numbers represented by four Vth ranges (programmed and erased states) per memory cell, TLC can be configured to store three data numbers represented by eight Vth ranges (programmed and erased states) per memory cell, QLC can be configured to store four data numbers represented by sixteen Vth ranges (programmed and erased states) per memory cell, and so on.

For example, when the memory cells in the 3D NAND flash memory use the MLC memory mode, the memory cells of the 3D NAND flash memory can be programmed to the four states corresponding to the bit codes 11, 10, 01, 00, namely the erased state E0, the programmed states P1, P2, P3. In another example, when the memory cells in the 3D NAND flash memory use a TLC memory mode, the memory cells of the 3D NAND flash memory may be programmed to an erased state and seven programmed states corresponding to the bit codes 111, 110, 010, 011, 001, 000, 100, 101. It should be noted that the memory mode type used by the memory cell is merely an example, and the memory device may also change the memory mode type corresponding to the memory cell, for example, change from SLC to QLC, change from QLC to SLC, etc., which is not limited in the examples of the present disclosure.

As the demand for memory capacity is improved, the current mainstream memory device adopts 3D NAND flash memory, and in order to pursue higher memory density, the number of stacked layers and the number of memory bits of a single memory cell of the 3D NAND flash memory are higher and higher. For example, in order to improve the memory density, the memory cell (for example, QLC) is usually configured to store data by using a higher number of memory bits, while the memory cell with a higher number of memory bits is relatively weaker in charge retention capability than a memory cell with a lower number of memory bits, and it is easy to cause problems such as loss or instability of stored data when the device is powered off for a long time, thereby affecting performance. For a solid state drive (SSD) in a client, when a QLC memory mode is used to store system file, it is easy to cause the client device to not be able to power on normally and quickly after shutdown for a certain period of time, thereby affecting user experience.

In order to meet the requirement that the client device is powered on normally and quickly after shutdown for a certain period of time, for a product with weak data retention capability such as a QLC type, a mixed type memory mode may be used, for example, the plurality of memory cells in the memory device include a first type of memory cell and a second type of memory cell, and memory levels of the first type of memory cell and memory levels of the second type of memory cell are different. The first type of memory cell is configured to be capable of being written with N-bit data, the second type of memory cell is configured to be capable of being written with M-bit data, and N is less than M.

The memory level is used to indicate the amount of stored data of each memory cell, for example, different memory levels such as SLC, MLC, TLC, QLC, and the like, and taking the following as an example: the second type of memory cell belongs to a QLC type. The first type of memory cell belongs to at least one of an SLC, an MLC, and a TLC type.

For example, because it is relatively slow for the system reading the related data from the QLC, or the complete data cannot be read during power on due to the weak data retention capability of the QLC, performance issues such as longer time of power on occurs. In order to avoid these performance issues, the first type of memory cell may be used to store the first type of data, the first type of data is the specific type of data, for example, the system file data of the operating system usually affects the time of power on when the system is powered on. Therefore, to ensure that the operating system can be normally initiated, the system file data may be stored as the first type of data in the first type of memory cell, for example, the system file data is stored in the memory cells other than the QLC type, for example, the memory cells of at least one of an SLC, an MLC, and a TLC type.

In some examples, the memory device may perform data migration based on a specific event, and the data migration refers to moving data stored in the memory device in a plurality of memory cells, for example, when the SSD is based on an event such as a garbage collection (GC) and a data refresh (Refresh), the data may be migrated from the first type of memory cell to the second type of memory cell.

In order to prevent reading the first type of data from the second type of memory cell during power on which affects the performance of power on, it is necessary to ensure that the first type of data is always stored in the first type of memory cell. For example, the memory array of the memory device in the examples of the present disclosure includes a plurality of memory cells, the plurality of memory cells includes a first type of memory cell and a second type of memory cell, the first type of memory cell is configured to store the first type of data (such as system file data) and other types of data, and the second memory cell is configured to store other types of data.

According to the examples of the present disclosure, the memory device comprising the plurality of types of memory cells is adopted, and by keeping the first type of data in the first type of memory cell, preventing reading the first type of data from the second type of memory cell with weaker data retention capability which results in the performance influence caused by data loss and the like, and for the first type of data influencing the performance of power on, the reading efficiency during power on is guaranteed, so that the performance of power on is guaranteed.

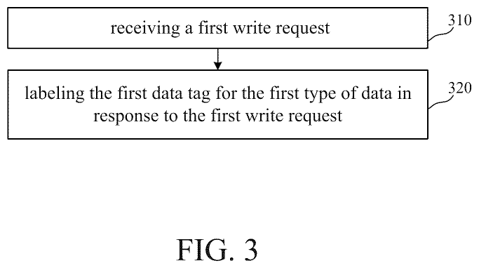

For example, referring to FIG. 3, which is a flowchart of a method for storing data according to an example of the present disclosure. As shown in FIG. 3, the method is performed by a memory system, and the method includes:

Operation 310: receiving a first write request.

The first write request includes a first type of data.

The first write request is a special write request configured for the first type of data for requesting to store the first type of data into a specified type of memory cell.

In some examples, the first write request corresponds to a special request format, and the data requested to be written by the received first write request is determined as the first type of data by identifying the special request format.

For example, the first write request includes a first identification bit, and the first identification bit is marked as a first value.

The first value represents a first request format corresponding to the first write request, and the first request format is a format set for the first type of data.

In some examples, the first write request is sent to the memory system by a host coupled to the memory system.

The memory system includes a memory device and a memory controller, and the host includes an interface and a processor coupled to the interface.

In some examples, the processor runs an operating system.

Optionally, the operating system may be a customized operating system developed specifically for the first write request.

The customized operating system is an operating system that supports a first request format.

The first write request is generated by the processor in the host based on the customized operating system when there is the first type of data to be stored, the processor sends the first write request to the memory controller through the interface, and the first write request indicates the memory controller to store the first type of data into a specific type of memory cell in the memory device.

Optionally, the customized operating system supports Non-Volatile Memory Express (NVMe) front-end protocol standard, and may generate a write request based on the customized operating system according to the NVMe front-end protocol standard.

The first write request conforms to the NVMe front-end protocol standard.

The first type of data is data that needs to be stored in a specific type of memory cell.

Taking the following as an example: the first type of data includes the system file data of the operating system. Because it is relatively slow for the system reading the related data from the memory cells, or the complete data cannot be read during power on due to the weak data retention capability of part of the memory cells, performance issues such as longer time of power on occurs. In order to avoid these performance issues, the first type of memory cell with a stronger data retention capability may be used to store the first type of data.

The system file data may be obtained in a process of installing an operating system, or may be generated based on a write operation for an operating system, and the host processor may automatically generate a first write request when there is any system file data to be stored.

For example, the host processor is configured to: in a process of installing an operating system, automatically generate a first write request; or after installing an operating system, receive a write operation for an operating system, and generate a first write request in response to the write operation.

Operation 320: labeling the first data tag for the first type of data in response to the first write request.

The first data tag indicates that the first type of data is stored in a first type of memory cell of the memory device.

Optionally, the first data tag may be a special mark used to mark the first type of data, and the special mark may be implemented as a special value set for the first type of data, for example, the first type of data tag value 1 is used as the first data tag; the special mark may also be implemented as a memory address of the first type of data, a first type of memory cell identification, or the like, used to indicate the memory information for storing the first type of data to the first type of memory cell, for example, labeling identification A to the first type of data as the first data tag, and the identification A indicates one memory cell in the first type of memory cell used to store the first type of data.

It should be noted that the tag content of the first data tag is merely an example, and the tag content of the first data tag is not limited in the examples of the present disclosure.

According to the method provided by the examples of the present disclosure, by using the special value as the tag content of the first data tag, so that the data labeling logic can be simplified, and the data processing efficiency is improved; by using the memory information as the tag content of the first data tag, the first data tag has the actual meaning, the first data label can represent the memory information of the first type of data, and the data expression effectiveness is improved.

The first data tag may be part of data content in the first type of data by rewriting the first type of data, or may be independent data content independent of the first type of data, which is not limited in the examples of the present disclosure.

Taking the first data tag being part of the data content of the first type of data as an example, for example, the first type of data includes the first data tag, the first data tag occupies the data bit in the first type of data, and the part of the data content in the first type of data is rewritten as the first data tag. For example, the data length of the first type of data includes a plurality of data bits, the plurality of data bits includes a first data bit, the first data bit is used to store the first data tag, before the first data tag is labeled to the first data bit, the first data bit is marked as a default value, and the first data tag is labeled to the first data bit by rewriting the first data bit with the tag value, where the tag value is different from the default value. For example, taking the first bit value of the first type of data being 0 as an example, the first bit value of the first type of data may be modified to 1 as the first data tag.

According to the method provided by the example of the present disclosure, by rewriting the first type of data to use the first data tag as part of the data content of the first type of data, so that the first data tag can be prevented from occupying additional memory space, and the data memory efficiency is improved.

Taking the following as an example: the first data tag is a concatenated data having a concatenation relationship with the first type of data, where the first data label can be inserted at any position before, after, or in the middle of the first type of data. For example, the data length of the first type of data includes a data bits, the data length of the first data tag includes b data bits, the first type of data is concatenated with the first data tag to obtain first type of data labeled with the first data tag, which occupies a+b data bits, and a and b are positive integers.

According to the method provided by the example of the present disclosure, by concatenating the first data label with the first type of data, the damage of data structure due to rewriting the first type of data can be avoided, the labeling process of the first type of data is achieved while the data quality is guaranteed, the association memory logic of the first type of data and the first data label is simplified, and the data memory efficiency is improved.

It should be noted that the form of the foregoing data labeling is merely an example, and this is not limited in the examples of the present disclosure.

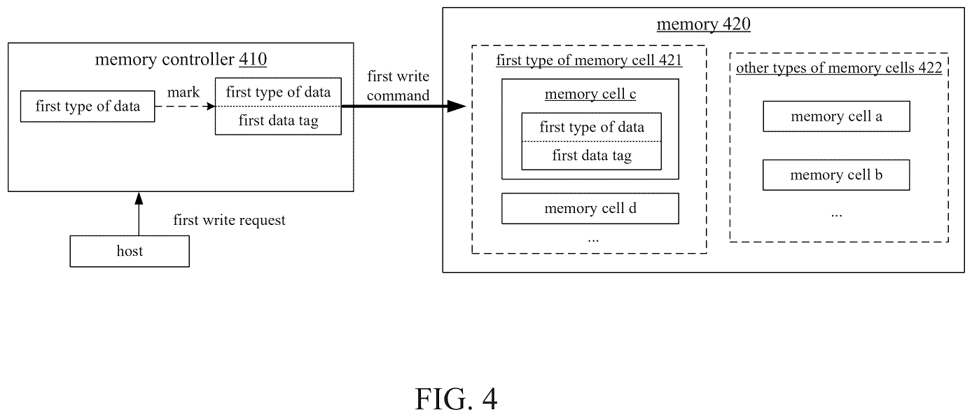

For example, referring to FIG. 4, FIG. 4 is a schematic diagram of a specific data labeling according to an example of the present disclosure. As shown in FIG. 4, the memory system includes a memory controller 410 and a memory device 420, the memory device 420 includes a first type of memory cell 421 and another type of memory cell 422, the memory controller 410 labels the first data tag for the first type of data in response to the first write request, and writes the first type of data into the first type of memory cell 421 based on the first data tag.

In some examples, the first write request includes a first identification bit, and the first identification bit is marked as a first value.

The first value represents a first request format corresponding to the first write request, and the first request format is a format set for the first type of data.

Optionally, the first request format is used to indicate a distribution format of content such as a target address, a data length, and a request type of the first type of data in the first write request.

In some examples, the first data tag is labeled for the first type of data based on the first value of the first identification bit.

For example, for the first identification bit in the normal write request, the default value is 0, for the first identification bit in the special write request, the first value is set to 1, and the first data tag is labeled for the first type of data based on the first value 1 of the first identification bit in the first write request.

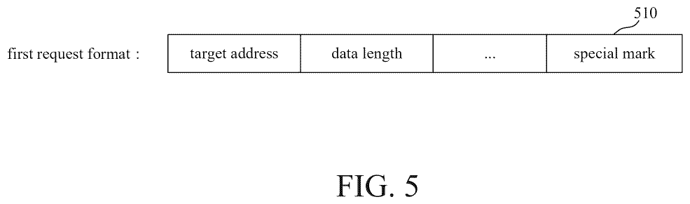

For example, referring to FIG. 5, FIG. 5 is a schematic diagram of a first request format according to an example of the present disclosure. As shown in FIG. 5, the first request format is used to indicate that the first write request includes, in sequence, request content such as a target address and a data length, where the first request format includes a special mark 510, the special mark 510 is located in a first identification bit of the first write request, and the write request is indicated as a first write request by marking the first identification bit as a first value.

According to the method provided by the example of the present disclosure, the first identification bit marked as the first value represents the first request format, so that the system can determine that the first write request is a special write request used for storing the first type of data into the memory cell with the specified type when the first identification bit marked as the first value is read, so that the first data tag is labeled for the first type of data in response to the first write request, where the first data tag indicates to store the first type of data in the first type of memory cell, the identification and response logic for the special write request is simplified, and the data memory efficiency is improved.

In summary, according to the method provided in the examples of the present disclosure, by adopting the specific write request for the specific type of data, labeling the data tag for the specific type of data, so that the data tag indicates the type of the memory cell of the specific type of data, so that the specific type of data can be ensured to be stored into the specific type of memory cell, thereby preventing the specific type of data from being stored in the memory cell in which the data loss and the like is easy to occur, for example, preventing the specific type of data from being stored into the QLC type of memory cell, so that when the device is powered on, the specific type of data can be quickly read from the specific type of memory cell without being influenced by the QLC type of memory cell, and the performance of power on is guaranteed.

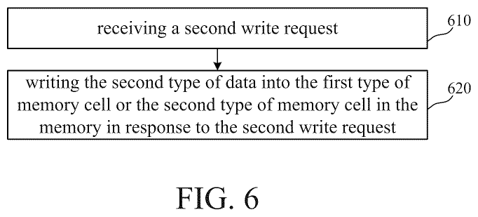

In some examples, a method for storing data according to the examples of the present disclosure further includes a write process of other types of data. For example, referring to FIG. 6, FIG. 6 is a flowchart of a method for writing other types of data according to an example of the present disclosure. As shown in FIG. 6, the method is performed by a memory system, and the method includes:

Operation 610: receiving a second write request.

The second write request includes a second type of data.

The second write request is used to request to write the second type of data into the memory device of the memory system.

The second type of data is another type of data other than the first type of data.

Taking the system being powered on scenario as an example, in order to reduce the time consumed by reading data during power on and ensure the performance of power on, the first type of data may be data that needs to be read when the system is powered on, the second type of data may be data that needs to be read after the system is powered on, the data retention requirement for the first type of data is high, therefore, the first type of data needs to be stored in a specific type of memory cell with a relatively stronger data retention capability, and the second type of data may be stored in any type of memory cell.

Optionally, the first type of data includes system file data, and the second type of data includes data other than the system file data.

The system file data is data corresponding to an operating system in the host, and is configured to support installation and operation of the operating system.

For example, the first type of data includes a disk image file of the operating system.

For example, the second type of data includes, but is not limited to, any type of data such as a user profile, application data, a driver file, a temporary file, a log file, a font file, a library file, a permission and policy file, a backup and recovery data, a network profile, a language and an area setting file, a security update, and a patch, which is not limited in the examples of the present disclosure.

The user profile includes personalized setting data of the user, such as a desktop background, a theme, a shortcut, an initiation program, and the like; the application data includes a profile and a data file of an application installed on the system, and is used to ensure normal operation of the application; the driver file includes an unsigned third party driver file and a driver file other than the system driver file, such as an unofficial driver software installed by the user, the system driver file includes program data based on a driver installed by the operating system, and is used to drive a hardware device of the system, and the system driver file belongs to the first type of data.

According to the method provided by the examples of the present disclosure, the first type of data is stored into the first type of memory cell by adopting the first write request for the system file data (the first type of data), the second type of data is stored into the first type of memory cell or the second type of memory cell by adopting the second write request for other data (the second type of data) other than the system file data, the first type of data is ensured to be kept in the first type of memory cell, so that in scenario such as the system power on, the first type of data can be quickly read from the first type of memory cell, and the problems of data loss and the like which affects the performance of system power on can be prevented.

In some examples, the second write request corresponds to a second request format, the second request format is set for the second type of data, and the second request format is different from the first request format.

Optionally, numbers of data bits respectively corresponding to the first request format and the second request format may be the same or different.

When the numbers of data bits respectively corresponding to the first request format and the second request format are the same, the second write request includes a first identification bit marked as a second value, and the second value is different from the first value.

When the numbers of data bits respectively corresponding to the first request format and the second request format are different, the second write request does not include the first identification bit.

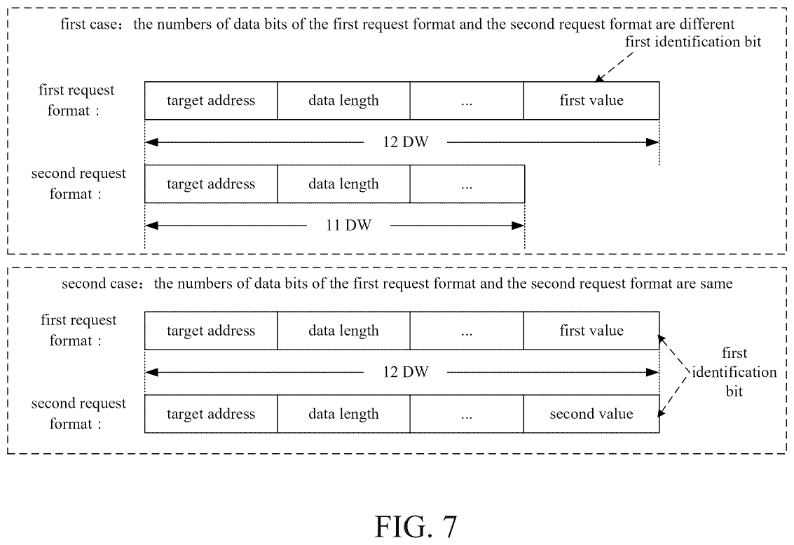

For example, referring to FIG. 7, FIG. 7 is a schematic diagram of a format of a specific write request and a normal write request according to an example of the present disclosure. As shown in FIG. 7, taking the write request comprising a plurality of double word (DW) data bits as an example, when the numbers of data bits respectively corresponding to the first request format and the second request format are different, the first request format indicates that the first write request includes 12 DWs comprising request content such as a target address, a data length, and a first identification bit. The first identification bit is marked as a first value, and the second request format indicates that the second write request includes 11 DWs comprising request content such as the target address, the data length, and the like and not comprising the first identification bit; when the numbers of data bits respectively corresponding to the first request format and the second request format are the same, the first request format indicates that the first write request includes 12 DWs comprising request content such as a target address, a data length, and a first identification bit, the first identification bit is marked as a first value, the second request format indicates that the second write request includes 12 DWs comprising request content such as a target address, a data length, and a first identification bit, the first identification bit is marked as a second value, and the first value is different from the second value.

According to the method provided by the example of the present disclosure, different request formats can be represented by different values of the same identification bit in the write request, e.g., the special write-in request and the ordinary write-in request can be distinguished by different values of the same identification bit in the write request. So as the data tag is labeled for the special type of data according to the special write request, the normal type of data is normally stored according to the normal write request. The way of distinguishing different write requests is provided, the response efficiency for different write requests is improved, and the data memory efficiency is improved.

Operation 620: writing the second type of data into the first type of memory cell or the second type of memory cell in the memory device in response to the second write request.

The first type of memory cell is configured to be capable of being written with N-bit data, the second type of memory cell is configured to be capable of being written with M-bit data, and N is less than M.

In some examples, the more the number of stored bits per unit data of the memory cell is, the weaker the data retention capability of the memory cell is, and therefore, the performance of storing for the first type of data can be ensured by avoiding storing the first type of data into the memory cell with more number of stored bits per unit data.

For example, the first type of memory cell includes at least one of SLC, MLC, and TLC, and the second type of memory cell includes QLC.

According to the method provided by the examples of the present disclosure, by using the second write request to write the second type of data into the first type of memory cell or the second type of memory cell, the normal processing of storing data for the ordinary data is realized, by writing the first type of data into the first type of memory cell through the first write request, the first type of data is kept in the first type of memory cell, the first type of data is prevented from being stored or migrated to the second type of memory cell such as the QLC, and the problem such as the first type of data is lost due to the data retention defect of the QLC is avoided.

In summary, according to the method provided in the examples of the present disclosure, by using an ordinary write request to write the ordinary type of data into the memory device, special processing is not required to be performed on the ordinary type of data, a solution for storing that is different from the ordinary type of data may be implemented for the special type of data based on the special write request, so that the special type of data is kept to be stored in the special type of memory cell without affecting the normal process of storing the ordinary type of data, and the data memory efficiency is improved.

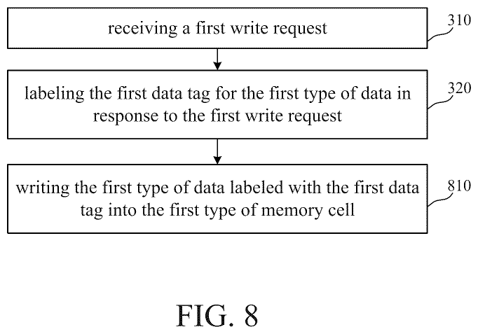

In some examples, the memory controller in the memory system needs to write the first type of data into the memory device, and the method for storing data provided in the examples of the present disclosure further includes a process of writing data for the first type of data. For example, referring to FIG. 8, FIG. 8 is a flowchart of a method for writing a first type of data according to an example of the present disclosure.

Operation 810: writing the first type of data labeled with the first data tag into the first type of memory cell.

In some examples, the memory controller sends the first type of data labeled with the first data tag to the memory device, and the memory device writes the first type of data labeled with the first data tag into the first type of memory cell.

The first data tag is used to indicate to write and keep the first type of data in the first type of memory cell.

Optionally, operation 810 includes the following two steps:

Operation 1: generating a write instruction in response to the first write request.

The write instruction includes a first type of data labeled with a first data tag and a first memory address corresponding to the first type of data.

The first memory address is used to indicate an address of a first type of memory cell for storing the first type of data in the memory device.

Optionally, the first memory address may be indicated by the first write request, or may be automatically allocated by the memory controller, which is not limited in the examples of the present disclosure.

Taking the first memory address being indicated by the first write request as an example, the first write request includes the first memory address, and the write instruction comprising the first memory address is generated based on the first write request.

Taking the first memory address being automatically allocated by the memory controller as an example, the memory controller obtains the storage status of the first type of memory cell in the memory device based on the first write request, where the storage status is used to indicate the idle first type of memory cell. Automatically allocate the first memory address based on the storage status and the data length of the first type of data, where the first memory address is used to indicate the storage space that can accommodate the first type of data in the idle first type of memory cell.

Operation 2: in response to the write instruction, writing the first type of data labeled with the first data tag in the first type of memory cell based on the first memory address.

The first type of data may occupy at least one of the first type of memory cell, or may occupy a part of storage space in the first type of memory cell, which is not limited in the examples of the present disclosure.

Taking the first type of data occupying at least one of the first type of memory cell as an example, the first memory address is used to indicate an address of at least one of the first type of memory cell for storing the first type of data in the memory device, and in response to the write instruction, the first type of data labeled with the first data tag is written into the at least one of the first type of memory cell based on the first memory address.

Taking the first type of data occupying a part of storage space in the first type of memory cell as an example, the first memory address is used to indicate an address of the first storage space storing the first type of data in the first type of memory cell, and the first storage space is a storage space used to store the first type of data in the first type of memory cell.

According to the method provided by the examples of the present disclosure, by generating the write instruction comprising the first memory address, indicating that the first type of data is stored into the first type of memory cell according to the first memory address, the first type of memory cell used for storing the first type of data can be accurately indicated through the first memory address, and accuracy and efficiency of storing data are provided.

In summary, according to the method provided by the examples of the present disclosure, by writing the first type of data labeled with the first data tag into the first type of memory cell, the first type of data is prevented from being written into other types of memory cells, and the first type of data is kept to be stored in the first type of memory cell based on the first data tag, so that the first type of data can be prevented from being stored in the memory cell with poor data retention capability such as QLC, the possibility of data loss of the first type is reduced, and the performance of storing data is improved.

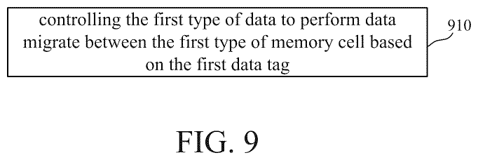

In some examples, the method for storing data provided in the examples of the present disclosure further includes a data migration process. For example, referring to FIG. 9, FIG. 9 is a flowchart of a method for migrating data based on a specific data tag according to an example of the present disclosure. As shown in FIG. 9, the method is performed by a memory system, and the method includes:

Operation 910: controlling the first type of data to perform data migrate between the first type of memory cell based on the first data tag.

In some examples, data migration may occur after the first type of data is stored in the first type of memory cell.

Optionally, the memory system may perform data migration in any case such as garbage collection, wear leveling, memory space optimization, data refresh, bad block management, and the like, which needs to move data from one memory cell to another memory cell.

The memory system includes a memory device and a memory controller, and the memory controller controls the first type of data stored in the memory device to perform data migrate between the first type of memory cell.

The first data tag is used to indicate to keep the first type of data in the first type of memory cell, so when data migration is performed on the first type of data, the first type of data is controlled to perform data migrate between the first type of memory cell based on the first data tag, for example, the first type of data is migrated from one of the first type of memory cell to another first type of memory cell, or the first type of data is kept not to be performed data migrate, and the first type of data is prevented from being migrated to another type of memory cell.

For example, taking the following as an example: the first type of memory cell includes a first memory cell and a second memory cell and the first type of data is stored in the first memory cell. In a wear leveling scenario, to prevent early wear of the first memory cell and prolong a service life of the memory cell, the memory controller may control the memory device to migrate data in the first memory cell to other memory cell, and for the first type of data in the first memory cell, the memory controller controls to perform data migrate the first type of data from the first memory cell to the second memory cell based on the first data tag.

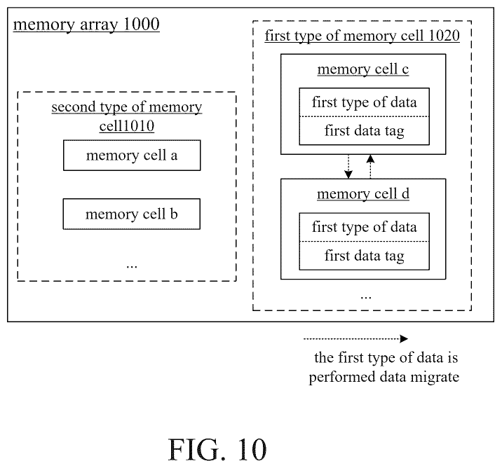

For example, referring to FIG. 10, FIG. 10 is a schematic diagram of data migration of the first type of data according to an example of the present disclosure. As shown in FIG. 10, a memory device of a memory system includes a memory array 1000, the memory array 1000 includes a first type of memory cell 1020 and a second type of memory cell 1010, the first type of memory cell 1020 and the second type of memory cell 1010 each include a plurality of memory cells. Taking the following as an example: the first type of memory cell 1020 includes a memory cell c and a memory cell d, and the second type of memory cell 1010 includes a memory cell a and a memory cell b. The first type of data is controlled to perform data migrate between the memory cell c and the memory cell d based on the first data tag.

The second type of data is another type of data other than the first type of data.

Optionally, the second type of data may be migrated between the first type of memory cell, or between the second type of memory cell, or between the first type of memory cell and the second type of memory cell, which is not limited in the examples of the present disclosure.

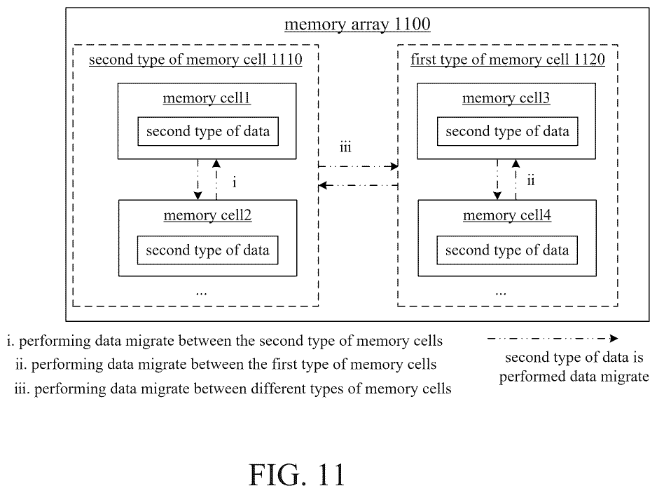

For example, referring to FIG. 11, FIG. 11 is a schematic diagram of data migration of other types of data according to an example of the present disclosure. As shown in FIG. 11, the second type of data corresponds to three manners for migrating data: i. data is migrated between the second type of memory cell; ii. data is migrated between the first type of memory cell; iii. data is migrated between different types of memory cells. For example, the memory system includes a memory device and a memory controller, the memory device includes a memory array 1100, the memory array 1100 includes a first type of memory cell 1120 and a second type of memory cell 1110, the first type of memory cell 1120 and the second type of memory cell 1110 each include a plurality of memory cells. Taking the following as an example: the first type of memory cell 1120 includes a memory cell 3 and a memory cell 4, and the second type of memory cell 1110 includes a memory cell 1 and a memory cell 2. When the second type of data has been stored in the second type of memory cell 1110, the memory controller may control to perform data migrate the second type of data in the second type of memory cell 1110, for example, migrate the data from the memory cell 1 to the memory cell 2, or the like, or the memory controller may also control to migrate the second type of data between the second type of memory cell 1110 and the first type of memory cell 1120, for example, migrate the data from the memory cell 1 to the memory cell 3, or the like; when the second type of data has been stored in the first type of memory cell 1120, the memory controller may control to migrate the second type of data in the first type of memory cell 1120, for example, migrate the data from the memory cell 3 to the memory cell 4, or the like, or the memory controller may also control to migrate the second type of data between the first type of memory cell 1120 and the second type of memory cell 1110, for example, migrate the data from the memory cell 3 to the memory cell 2, or the like.

It should be noted that the foregoing data migration scenario is merely an example, and this is not limited in the examples of the present disclosure.

In summary, according to the method provided in the examples of the present disclosure, by controlling the first type of data to perform data migrate between the first type of memory cell based on the first data tag, avoiding to store the first type of data into other memory cell (for example, QLC) other than the first type of memory cell due to data migration, thereby avoiding data loss and improving the performance of storing data.

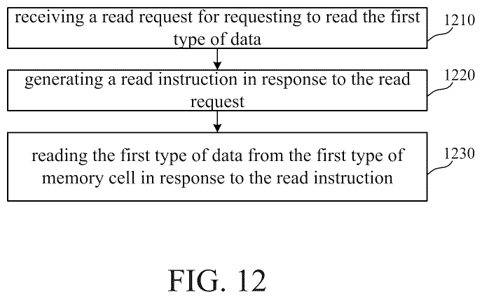

In some examples, the method for storing data provided in the examples of the present disclosure further includes a data read process. For example, referring to FIG. 12, FIG. 12 is a flowchart of a method for reading data according to an example of the present disclosure. As shown in FIG. 12, the method is performed by a memory system, and the method includes:

Operation 1210: receiving a read request for requesting to read the first type of data.

In some examples, the read request is sent by a host in a system having a memory system, and an operating system is installed in the host.

Taking the first type of data comprising system file data of the operating system as an example, the read request is generated and sent when the host needs to read the system file data, for example, the host generates and sends a read request to indicate the memory system to read the system file data when the operating system is initiated.

For example, a memory system includes a memory device and a memory controller configured to receive a read request for requesting to read the first type of data.

Operation 1220: generating a read instruction in response to the read request.

The read instruction includes an address of a first type of memory cell for storing the first type of data in the memory device.

For example, a memory system includes a memory device and a memory controller configured to generate a read instruction in response to a read request.

The read request includes an address information of the first type of data, and the address information is used to indicate an address of the first type of memory cell for storing the first type of data in the memory device.

For example, the read request includes a virtual address of the first type of data, the memory controller uses a memory management unit (MMU) to convert the virtual address to a physical address, and generates a read instruction according to the physical address, where the read instruction includes the physical address of the first type of data.

Operation 1230: reading the first type of data from the first type of memory cell in response to the read instruction.

For example, the memory system includes a memory device and a memory controller, and the memory device is configured to read the first type of data from the first type of memory cell in response to the read instruction.

In some examples, the memory device includes an address coder, the address coder is configured to compile and decode the physical address in the read instruction, the memory device locates the first type of memory cell for storing the first type of data according to the obtained physical address, and reads the first type of data from the first type of memory cell and returns to the memory controller.

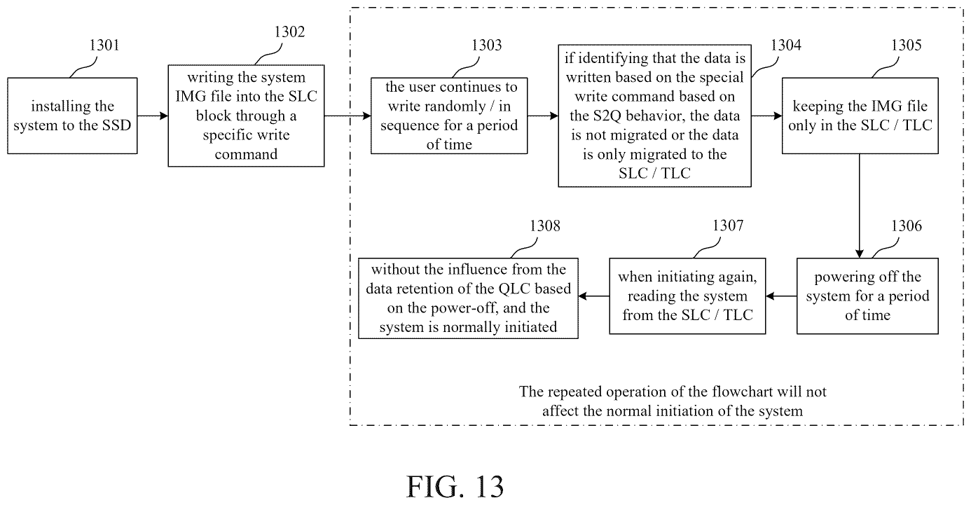

For example, referring to FIG. 13, FIG. 13 is a schematic logical flowchart of an operation for storing data according to an example of the present disclosure. As shown in FIG. 13, the following operations are performed in sequence based on the method for storing data provided in the examples of the present disclosure: operation 1301, installing the system to the SSD, for example, copying the system file data of the customized operating system installed in the host to the SSD (the system IMG file), so that the system IMG file becomes the memory medium for initiating and running the customized operating system; operation 1302, writing the system IMG file into the SLC block through a specific write command, where the system IMG file is the first type of data, the specific write command is the first write request, and the SLC block is the first type of memory cell; operation 1303, the user continues to write randomly/in sequence for a period of time; operation 1304, if identifying that the data is written based on the special write command based on the S2Q behavior, the data is not migrated or the data is only migrated to the SLC/TLC, where the S2Q behavior refers to the data migration behavior that migrates the data from the SLC to the QLC, the data written based on the special write command is the first type of data labeled with the first data tag, where the SLC/TLC is the first type of memory cell. In the data migration scenario, the first type of data is controlled to be kept in the first type of memory cell based on the first data tag, for example, the first type of data is controlled not to be performed data migrate, or the first type of data is controlled to be performed data migrate between the first type of memory cell; Operation 1305, keeping the IMG file only in the SLC/TLC, for example, keeping the first type of data in the first type of memory cell; Operation 1306, powering off the system for a period of time; Operation 1307, when initiating again, reading the system from the SLC/TLC, for example, when initiating the operating system again, reading the first type of data from the first type of memory cell; Operation 1308, without the influence from the data retention of the QLC based on the power-off, and the system is normally initiated, where since the first type of memory cell does not include the QLC, the first type of data can be prevented from being stored in the QLC by keeping the first type of data in the first type of memory cell, so that after the system is powered off, the first type of data cannot be lost due to the weak data retention capability of the QLC, thereby the performance of power on is not affected.

Repeatedly performing the operation 1303 to operation 1308 will not affect the normal initiation of the system.

In summary, according to the method provided in the examples of the present disclosure, by reading the first type of data stored in the first type of memory cell, data loss caused by storing the first type of data in other types of memory cells can be avoided, and data reading efficiency is improved.

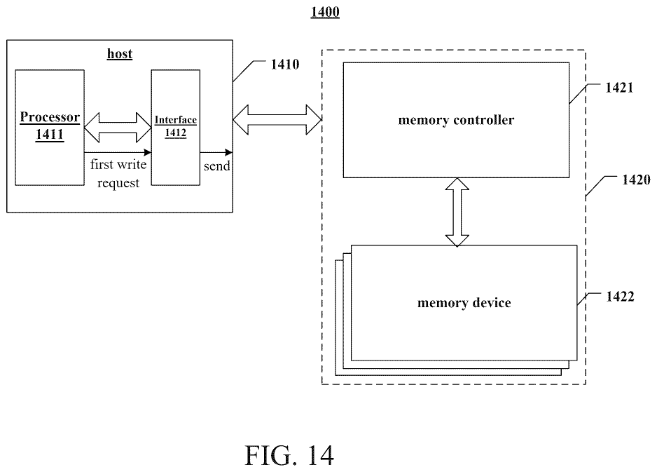

In some examples, a system having a memory system further includes a host. For example, referring to FIG. 14, FIG. 14 is a schematic structural diagram of a host according to an example of the present disclosure. As shown in FIG. 14, a system 1400 having a memory system 1420 includes a host 1410, the memory system 1420 includes a memory controller 1421 and a memory device 1422, the host 1410 includes an interface 1412 and the processor 1411 coupled to the interface 1412.

In some examples, the processor 1411 is configured to send a first write request to a memory controller through the interface, where the first write request includes a first type of data, the first write request indicates the memory controller to label a first data tag for the first type of data, and the first data tag indicates that the first type of data is stored in a first type of memory cell of a memory device.

In some examples, the processor 1411 is further configured to send a second write request to the memory controller through the interface, where the second write request includes a second type of data, and the second write request indicates to write the second type of data to the first type of memory cell or a second type of memory cell of the memory device, where the first type of memory cell is configured to be capable of being written with N-bit data, the second type of memory cell is configured to be capable of being written with M-bit data, and N is less than M.

In some examples, the first type of data includes system file data of an operating system, and the second type of data includes other data other than the system file data.

In some examples, the processor 1411 runs an operating system, and the first type of data includes system file data of the operating system; and the processor 1411 is further configured to automatically generate the first write request during an installation of the operating system. Or, the processor 1411 is further configured to, after the operating system is installed, receive a write operation for the operating system, and generate the first write request in response to the write operation.

Optionally, the operating system may be a customized operating system developed specifically for the first write request.

The customized operating system is an operating system that supports a first request format.

The first write request is generated by the processor in the host based on the customized operating system when there is the first type of data to be stored, the processor sends the first write request to the memory controller through the interface, and indicates the memory controller to store the first type of data into a specific type of memory cell in the memory device by the first write request.

Optionally, the customized operating system supports NVMe front-end protocol standard, and may generate a write request according to the NVMe front-end protocol standard based on the customized operating system.

The first write request conforms to the NVMe front-end protocol standard.

For example, the customized operating system generates a first write request for the first type of data, and generates a second write request for second type of data, where the first write request includes a first identification bit marked as a first value, the first value represents a first request format corresponding to the first write request, and the first request format is a format set for the first type of data; the second write request includes a first identification bit marked as a second value, the first value is different from the second value, or the second write request does not include the first identification bit.

In some examples, the processor 1411 is further configured to: send a read request for requesting to read the first type of data to the memory controller through the interface when the operating system is initiated, where the read request indicates to read the first type of data from the first type of memory cell.

In some examples, the memory device includes a first type of memory cell and a second type of memory cell; the first type of memory cell includes at least one of a SLC, a MLC, and a TLC; and the second type of memory cell comprises a QLC.

In summary, according to the host provided in the examples of the present disclosure, by generating a specific write request for the specific type of data, indicating the memory system to label the data tag for the specific type of data, so that the data tag indicates the type of the memory cell of the specific type of data, thereby ensuring that the specific type of data is stored in the specific type of the memory cell, thereby preventing the specific type of data from being stored in the memory cell in which the data loss and the like is easy to occur, for example, preventing the specific type of data from being stored into the QLC type of memory cell, so that when the device is powered on, the specific type of data can be quickly read from the specific type of the memory cell without being influenced by the QLC type of the memory cell, and the performance of power on is guaranteed.

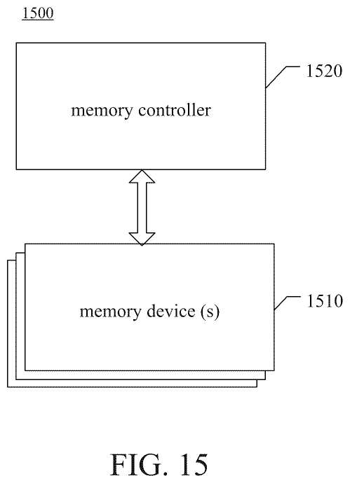

For example, referring to FIG. 15, FIG. 15 is a schematic structural diagram of a memory system according to an example of the present disclosure. As shown in FIG. 15, the memory system 1500 includes a memory control 1520 and a memory device 1510.

In some examples, the memory controller 1520 is configured to receive a first write request, where the first write request includes a first type of data; and label a first data tag for the first type of data in response to the first write request, where the first data tag indicates that the first type of data is stored in a first type of memory cell of the memory device.

In some examples, the first write request includes a first identification bit, the first identification bit is marked as a first value, the first value represents a first request format corresponding to the first write request, and the first request format is a format set for the first type of data.

In some examples, the memory controller 1520 is further configured to label the first data tag for the first type of data based on the first value of the first identification bit.

In some examples, the memory controller 1520 is further configured to receive a second write request, where the second write request includes a second type of data; and write the second type of data into the first type of memory cell or a second type of memory cell in the memory device in response to the second write request, where the first type of memory cell is configured to be capable of being written with N-bit data, the second type of memory cell is configured to be capable of being written with M-bit data, and N is less than M.

In some examples, the first type of data includes system file data of an operating system, and the second type of data includes other data other than the system file data.

In some examples, a second value of the first identification bit in the second write request is different from the first value.

In some examples, the memory controller 1520 is further configured to send the first type of data labeled with the first data tag to the memory device.

The memory device 1510 is configured to write the first type of data labeled with the first data tag into the first type of memory cell.

In some examples, the memory controller 1520 is further configured to send a write instruction to the memory device, where the write instruction includes the first type of data labeled with the first data tag and a first memory address corresponding to the first type of data.

The memory device 1510 is further configured to receive the write instruction; in response to the write instruction, write the first type of data labeled with the first data tag in the first type of memory cell based on the first memory address.

In some examples, the memory controller 1520 is further configured to control the first type of data to perform data migrate between the first type of memory cell based on the first data tag.

In some examples, the memory controller 1520 is further configured to: receive a read request for requesting to read the first type of data; and in response to the read request, send a read instruction to the memory device, where the read instruction includes an address of a first type of memory cell for storing the first type of data;

The memory device 1510 is configured to: receive the read instruction; and in response to the read instruction, read the first type of data from the first type of memory cell.

In some examples, the memory device includes the first type of memory cell and the second type of memory cell; the first type of memory cell includes at least one of a Single-Level Cell (SLC), a Multi-Level Cell (MLC), and a Trinary-Level Cell (TLC); and the second type of memory cell includes a Quad-Level Cell (QLC).

In summary, according to the memory system provided by the examples of the present disclosure, by adopting the specific write request for the specific type of data, labeling the data tag for the specific type of data, so that the data tag indicates the type of the memory cell of the specific type of data, so that the specific type of data can be ensured to be stored into the specific type of memory cell, thereby preventing the specific type of data from being stored in the memory cell in which the data loss and the like is easy to occur, for example, preventing the specific type of data from being stored into the QLC type of memory cell, so that when the device is powered on, the specific type of data can be quickly read from the specific type of the memory cell without being influenced by the QLC type of memory cell, and the performance of power on is guaranteed.

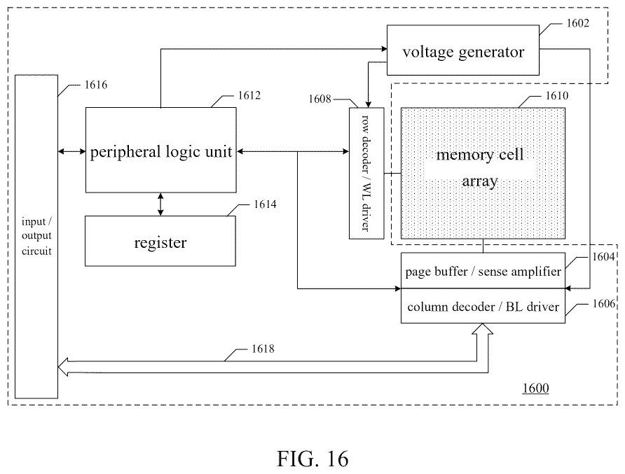

FIG. 16 is a schematic structural diagram of a memory device according to an example of the present disclosure. As shown in FIG. 16, the memory device includes a peripheral circuit 1600 and a memory cell array 1610.

The peripheral circuit 1600 is configured to write data into the memory cell array 1610 and read data from the memory cell array 1610.

The peripheral circuit 1600 includes a voltage generator 1602, a page buffer/sense amplifier 1604, a column decoder/bit line (BL) driver 1606, a row decoder/word line (WL) driver 1608, a peripheral logic unit 1612, a register 1614, an input/output circuit 1616, and a data bus 1618. In some examples, additional peripheral circuits not shown in FIG. 16 may also be included.

The page buffer/sense amplifier 1604 may be configured to read data from and program (write) data into the memory cell array 1610 according to control signals from the peripheral logic unit 1612. In one example, the page buffer/sense amplifier 1604 may store a page of programming data (write data) to be programmed into one page of the memory cell array 1610. In another example, the page buffer/sense amplifier 1604 may perform a program verify operation to ensure that the data has been correctly programmed into the memory cell coupled to the selected word line. In yet another example, the page buffer/sense amplifier 1604 may also sense a low power signal from the bit line representing a data bit stored in the memory cell, and amplify the small voltage swing to an identifiable logic level in a read operation.

Column decoder/bit line driver 1606 may be configured to be controlled by peripheral logic unit 1612 and select one or more NAND memory strings by applying a bit line voltage generated from voltage generator 1602.

The row decoder/word line driver 1608 may be configured to be controlled by the peripheral logic unit 1612 and select/deselect blocks of the memory cell array 1610 and select/deselect the word lines of the block. The row decoder/word line driver 1608 may also be configured to drive a word line using the word line voltage (V_{WL}) generated from the voltage generator 1602. In some implementations, the row decoder/word line driver 1608 may also select/deselect and drive the source select gate line and the drain select gate line. For example, the row decoder/word line driver 1608 is configured to perform an erase operation on memory cell coupled to the selected word line(s).

The voltage generator 1602 may be configured to be controlled by the peripheral logic unit 1612 and generate word line voltages (e.g., read voltages, program voltages, pass voltages, local voltages, verify voltages, etc.), bit line voltages, and source line voltages to be supplied to the memory cell array 1610.

Peripheral logic unit 1612 may be coupled to each peripheral circuit described above and configured to control operation of each peripheral circuit. The peripheral logic unit 1612 includes a control circuit as shown in FIG. 16 above.

Registers 1614 may be coupled to peripheral logic unit 1612 and include status registers, command registers, and address registers for storing status information, command operation codes (OP codes), and command addresses for controlling operation of each peripheral circuit. Input/output circuit 1616 may be coupled to peripheral logic unit 1612 and act as a control buffer to buffer control commands received from a host (not shown) and relay it to peripheral logic unit 1612 and buffer status information received from peripheral logic unit 1612 and relay it to the host. The input/output circuit 1616 may also be coupled to the column decoder/BL driver 1606 via a data bus 1618 and act as a data input/output interface and a data buffer to buffer data and relay it to the memory cell array 1610 or buffer or relay data from the memory cell array 1610.

The temperature sensor 1620 is configured to collect ambient temperature and output temperature sensing data to the peripheral circuit 1600. In some examples, the output end of the temperature sensor 1620 is connected to the input/output circuit 1616 of the peripheral circuit 1600, and the temperature sensing data is transmitted to the peripheral logic unit 1612 through the input/output circuit 1616.

It should be emphasized that the peripheral circuit 1600 is configured to perform the method for storing data provided in the examples of the present disclosure for a selected row of memory cell in a plurality of rows of memory cell.

An example of the present disclosure provides an electronic device. The electronic device comprises one or more memory systems according to any one of the above examples, and a host coupled to the memory system according to any one of the above examples.

An example of the present disclosure provides a computer-readable memory medium storing an instruction therein, the instruction, when executed on a control circuit, implements a method for storing data according to the above examples of the present disclosure.

In the present disclosure, the terms “first” and “second” are for descriptive purposes only and are not to be construed as indicating or implying relative importance. The term “at least one” refers to one or more, and the term “plurality” refers to two or more unless specifically defined otherwise.

The term “and/or” in the present disclosure is merely an association relationship for describing an associated object, it indicates that there may be three relationships, for example, A and/or B, which may indicate that only A is present, both A and B are present, and only B is present. In addition, the character “/” herein generally indicates that the relationship between the associated objects before and after “/” is “or”.

The above descriptions are merely examples of the present disclosure, and are not intended to limit the present disclosure, and any modifications, equivalent substitutions and improvements made within the spirit and principle of the present disclosure should be included in the protection scope of the present disclosure.

What is claimed is:

1. A memory system, comprising:
a memory device; and
a memory controller coupled to the memory device and configured to:
receive a first write request, wherein the first write request comprises a first type of data; and
label a first data tag for the first type of data in response to the first write request, wherein the first data tag indicates that the first type of data is stored in a first type of memory cell of the memory device.

2. The memory system of claim 1, wherein the first write request comprises a first identification bit, the first identification bit is marked as a first value, the first value represents a first request format corresponding to the first write request, and the first request format is a format set for the first type of data.

3. The memory system of claim 2, wherein the memory controller is further configured to label the first data tag for the first type of data based on the first value of the first identification bit.

4. The memory system of claim 2, wherein the memory controller is further configured to:
receive a second write request, wherein the second write request comprises a second type of data; and
write the second type of data into the first type of memory cell or a second type of memory cell in the memory device in response to the second write request, wherein the first type of memory cell is configured to be capable of being written with N-bit data, the second type of memory cell is configured to be capable of being written with M-bit data, and N is less than M.

5. The memory system of claim 4, wherein the first type of data comprises system file data of an operating system, and the second type of data comprises data other than the system file data.

6. The memory system of claim 4, wherein a second value of the first identification bit in the second write request is different from the first value.

7. The memory system of claim 1, wherein:
the memory controller is further configured to send the first type of data labeled with the first data tag to the memory device; and
the memory device is configured to write the first type of data labeled with the first data tag into the first type of memory cell.

8. The memory system of claim 7, wherein:
the memory controller is further configured to send a write instruction to the memory device, wherein the write instruction comprises the first type of data labeled with the first data tag and a first memory address corresponding to the first type of data; and
the memory device is further configured to:
receive the write instruction; and
in response to the write instruction, write the first type of data labeled with the first data tag in the first type of memory cell based on the first memory address.

9. The memory system of claim 1, wherein the memory controller is further configured to control the first type of data to perform data migrate between the first type of memory cell based on the first data tag.

10. The memory system of claim 1, wherein:
the memory controller is further configured to:
receive a read request for requesting to read the first type of data; and
in response to the read request, send a read instruction to the memory device,
wherein the read instruction comprises an address of a first type of memory cell for storing the first type of data; and
the memory device is configured to:
receive the read instruction; and
in response to the read instruction, read the first type of data from the first type of memory cell.

11. The memory system of claim 1, wherein:
the memory device comprises the first type of memory cell and a second type of memory cell;
the first type of memory cell comprises at least one of a Single-Level Cell (SLC), a Multi-Level Cell (MLC), or a Trinary-Level Cell (TLC); and
the second type of memory cell comprises a Quad-Level Cell (QLC).

12. A host, comprising:
an interface; and
a processor coupled to the interface and configured to:
send a first write request to a memory controller through the interface, wherein the first write request comprises a first type of data, the first write request indicates the memory controller to label a first data tag for the first type of data, and the first data tag indicates that the first type of data is stored in a first type of memory cell of a memory device.

13. The host of claim 12, wherein the processor is further configured to send a second write request to the memory controller through the interface, wherein the second write request comprises a second type of data, and the second write request indicates to write the second type of data to the first type of memory cell or a second type of memory cell of the memory device, wherein the first type of memory cell is configured to be capable of being written with N-bit data, the second type of memory cell is configured to be capable of being written with M-bit data, and N is less than M.

14. The host of claim 13, wherein:
the first write request comprises a first identification bit, the first identification bit is marked as a first value, the first value represents a first request format corresponding to the first write request, and the first request format is a format set for the first type of data; and
a second value of the first identification bit in the second write request is different from the first value.

15. The host of claim 12, wherein:
the processor runs an operating system;
the first type of data comprises system file data of the operating system; and
the processor is further configured to:
automatically generate the first write request during an installation of the operating system; or
after the operating system is installed, receive a write operation for the operating system, generate the first write request in response to the write operation.

16. The host of claim 15, wherein: the processor is further configured to send a read request for requesting to read the first type of data to the memory controller through the interface when the operating system is initiated, wherein the read request indicates to read the first type of data from the first type of memory cell.

17. A method of storing data, comprising:
receiving a first write request, wherein the first write request comprises a first type of data; and
labeling a first data tag for the first type of data in response to the first write request, wherein the first data tag indicates that the first type of data is stored in a first type of memory cell in a memory device.

18. The method of claim 17, wherein the first write request comprises a first identification bit, the first identification bit is marked as a first value, the first value represents a first request format corresponding to the first write request, and the first request format is a format set for the first type of data.

19. The method of claim 18, wherein the labeling the first data tag for the first type of data in response to the first write request comprises labeling the first data tag for the first type of data based on the first value of the first identification bit.

20. The method of claim 18, further comprising:
receiving a second write request, wherein the second write request comprises a second type of data; and
writing the second type of data into the first type of memory cell or a second type of memory cell in the memory device in response to the second write request, wherein the first type of memory cell is configured to be capable of being written with N-bit data, the second type of memory cell is configured to be capable of being written with M-bit data, and N is less than M.
